(19) United States
(12) Patent Application Publication
(10) Pub. No.: US 2005/0097180 A1
(43) Pub. Date: May 5, 2005

(54) System and method for improved customized portal web pages

(76) Inventor: Aaron Abdelhak, New York, NY (US)

Correspondence Address: OSTROLENK FABER GERB & SOFFEN, 1180 AVENUE OF THE AMERICAS, NEW YORK, NY, 100368403, US

(21) Appl. No.: 10/780,212

(22) Filed: Feb. 17, 2004

Related U.S. Application Data
(63) Continuation-in-part of application No. 10/698,699, filed on Oct. 31, 2003.

(51) Int. Cl. G06F 15/16

(52) U.S. Cl. 709/208; 709/211; 709/218; 709/227; 709/203

(57) ABSTRACT

A system and method for providing a personal Internet portal page to a user that displays at least some content selected by the user from a different Internet web site. The personal Internet portal page of the present invention displays at least some content from by the user. Moreover, the present invention provides a personal Internet portal page that operates a software application that is provided by the user. The present invention provides an Internet portal that obtains a live feed of data from one or more of servers. The data are provided in accordance with predefined criteria and presented in one or more encapsulated formats. The formats can be customized to accommodate individual preferences.

### CROSS-REFERENCE TO RELATED APPLICATIONS

This patent application claims priority to, and is a continuation-in-part of, U.S. patent application Ser. No. 10/698,699, and entitled SYSTEM AND METHOD FOR CUSTOMIZED PORTAL WEB PAGES, the entire contents of which are incorporated herein by reference.

### FIELD OF THE INVENTION

The present invention relates generally to Internet web page development, and, more particularly, to a system and method for providing user customized portal web pages.

### BACKGROUND OF THE INVENTION

A typical Internet-based search engine includes a web site having a user interface for visitors to submit a search request comprising terms describing the web sites the visitors wish to access. The typical search engine also includes a search engine database that stores information regarding other Internet web sites. The database is automatically referenced when a search request is submitted by a user, typically caused by the user entering search terms and then selecting a graphic icon, such as a windowed button. The database provides the names and descriptions of web sites that match the search request, and the search engine web site formats the names and descriptions of the matched web sites, typically as hyperlinks, thereby enabling the users to review and access the respective sites. A web page that provides search engine functionality, along with a information content provided from a third party, for example, www.cnn.com, is known in the industry as a “portal”.

Proprietors of portals recognize that users prefer to customize the computing environment in which they operate. Accordingly, portals are available, for example, from my.yahoo.com and my.msn.com that are, to a degree, customizable to a user's preferences. Typically, a user first “registers” with a proprietor of a portal by providing a unique user name and password, in addition to other information desired by the proprietor, and is assigned a customizable template of a portal. Once registered, the user customizes the template by selecting options for various content to be displayed in the portal, and also to manipulate basic formatting of the display of the portal, such as colors and text font types. Typically, the registered user is presented with his personal Internet portal after supplying his user name and password.

Referring to the drawing figures, in which like designators refer to like elements, there is shown in FIG. 1 an example prior art Internet web portal 100. The depiction shown in FIG. 1 is an example default portal layout provided for non-registered users, and is located at the web site, HTTP://MY.MSN.COM. As shown in FIG. 1, content boxes 2 contain current information content from a plurality of sources. For example, news photos and headlines, local weather and weather from a plurality of cities, and stock quotes are provided. Many of the content boxes 2 are formatted as hyperlinks to other web site pages. Further, advertisement links 104 show advertisements from various third parties. User login box 106 enables a user to submit a user name and password in order to customize the design of a portal page, or to access an existing portal 100. Further, portal display configuration box 108 enables the user to choose content, colors, and a layout for portal 100.

Many portals contain advertisements for various goods and services from third parties. Advertising is viewed as an effective way to defray the high cost of providing Internet-related services. The advertisements are usually formatted as digital graphic files, such as JPEG files, and occupy portions of the web browser display screen where viewers are likely to look, such as at the top and bottom of a web page. The advertisements frequently include hyperlinks to e-commerce web sites where goods or services can be purchased.

Users often find advertisements in web sites to be undesirable because they are distracting. The sophistication of Internet web site development tools, such as COLDFUSION and DREAMWEAVER as well as evolution of the JAVA programming language has enabled developers to add audio and visual content, including motion and other visual effects, to web site advertisements in the hope of getting users' attention. Also, hyperlinks in web site advertisements are often mistakenly selected, thereby causing further interruption by presenting different web pages.

As shown in FIG. 1, advertisement links 104 occupy a significant amount of the display. For example, advertising is shown for the Internet portal itself (“my.msn”), high-speed Internet access, and an advertisement for receiving news. As noted above, advertisement links 104 often contain moving images and sounds, such as is available in a MACROMEDIA FLASH application, and, unfortunately, distract the user's attention and diminish the user's enjoyment.

Users of Internet portals, such as my.msn.com and my.yahoo.com, desire greater flexibility in content and design than that typically provided. Typical prior art portals provide limited customization with respect to appearance and content. For example, a registered user may select from a variety of sources of content and select from a variety of colors and typefaces. However, prior art portals support customizing the overall appearance of a portal, and do not support the customization of particular regions of the portal. Further, prior art portals do not support integration of one or more software applications that are uploaded to a server and used by one or more registered users. For example, a user may desire to install a custom viewer of a moving image file (e.g., an audio video interleave or “AVI” file) into a personal Internet portal page. Unfortunately, such integration of a custom AVI player into a prior art portal page is not available in the prior art.

U.S. Patent Application Publication No. 2002/0156812, entitled “Method and System for Assembling Concurrently-Generated Content,” teaches providing content in a portal that is hosted by a plurality of distinct servers in response to a single request from a client. This reference attempts to increase user flexibility with respect to Internet portal content. International Patent Publication No. WO 02/01388, entitled “Portal Server that Provides a Customizable User Interface for Access to Computer Networks,” teaches providing a plurality of network resources via an administration interface in which a user selects layout styles and schemes, as well as content from a set of servers to be displayed in a portal. Further, U.S. Patent Application Publication No. 2003/0101412, entitled “User Aggregation of Webpage Content,” teaches methods and products for a user to identify a target web page which is virtually dissected to extract specific content therein. The content is then displayed with other such extracted content in a portal.

These prior art references, however, are not tools for the masses of Internet users. Systems that provide extreme degrees of flexibility envisioned for the user are simply too complex and impractical to be implemented in a large scale environment, such as that supported by YAHOO and MSN. Further, these references do not provide a level of customization desired by users, with respect to portals.

### SUMMARY OF THE INVENTION

The present invention provides a personal Internet portal page that displays content received by a registered user in customizable ways. Further, the personal Internet portal page of the present invention comprises one or more portal sections that comprise the portal page. Each portal section is customizable with respect to appearance and content.

The present invention provides an interface in which a sample of computer executable code, i.e., software, representing a portal section is available for review by a registered user, and can be used as a template for developing one or more other portal sections not originally provided by the provider of the Internet portal.

The present invention further allows a user to upload content, such as still and moving images, audio files and other information content to a personal storage cache that can be accessed on the portal.

The present invention further includes an interface that includes a representation of a portal page, and that includes controls that allow a user to design a personal Internet portal page by selecting an icon that represents a portal section which can dragged into a template that represents the portal page. The icon representations can be sized and moved according to the user's preferences.

The present invention further provides a portal that allows a user to display information from one or more e-mail accounts that may be unrelated to the service providing the portal.

The present invention further provides a portal that allows a user to upload personal information to a personal information management component of the portal. For example, a calendar of events, personal contacts, notes and calculator are available in the portal of the present invention.

The present invention further provides a portal that substantially automatically displays a predetermined web site for a predetermined amount of time, and then displays another predetermined web site, or, alternatively, returns to the portal, substantially automatically.

The present invention also provides a portal that qualitatively analyzes information displayed therein, and, in response to data-related events such as changing information, provides an alert for the user that a data-related event has occurred.

Other features and advantages of the present invention will become apparent from the following description of the invention which refers to the accompanying drawings.

### BRIEF DESCRIPTION OF THE DRAWINGS

For the purposes of illustrating the invention, there is shown in the drawings a form which is presently preferred, it being understood, however, that the invention is not limited to the precise arrangements and instrumentalities shown. The features and advantages of the present invention will become apparent from the following description of the invention that refers to the accompanying drawings, in which:

FIG. 1 shows an example prior art Internet web portal;

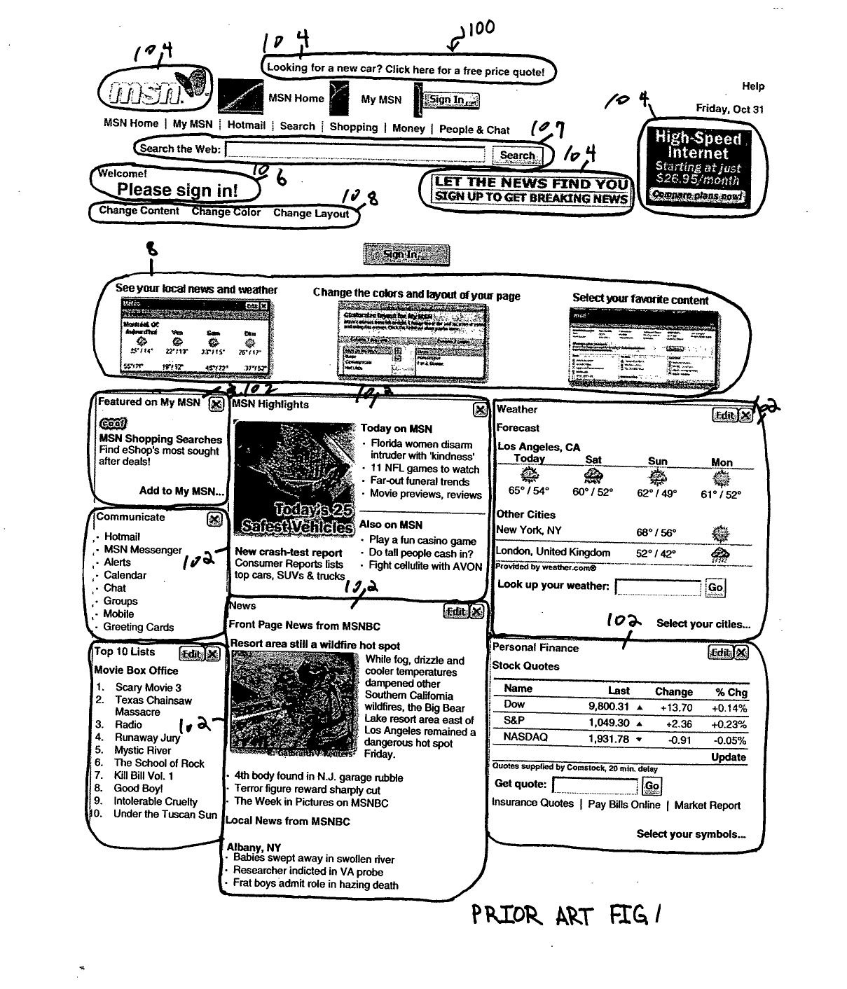

FIG. 2 shows an example hardware arrangement of a preferred embodiment of the present invention;

FIG. 3 is a block diagram illustrating the functional elements in an example information processor;

FIG. 4 is an example web site display screen enabling a user to access a personal Internet portal page;

FIG. 5 is an example personal Internet portal page design display screen;

FIG. 6 is an example personal Internet portal page designed in accordance with the present invention;

FIG. 6A shows an example e-mail notification display screen that is provided to a registered user in accordance with the present invention; and

FIG. 107 is a flow chart showing a high level representation of administrative functionality.

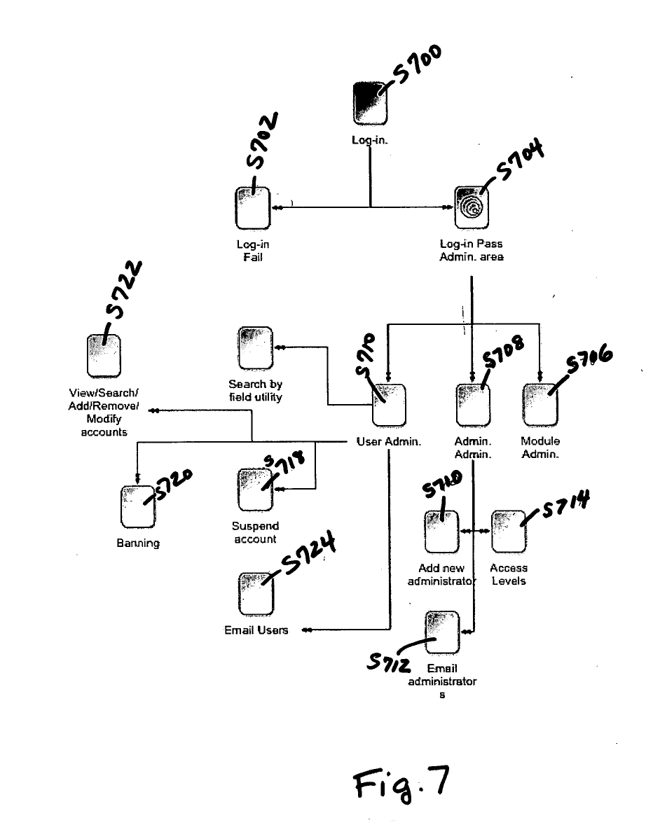

### DETAILED DESCRIPTION OF PREFERRED EMBODIMENTS OF THE INVENTION

The present invention provides a personal Internet portal page that includes an interface for customizing the portal page to a user's personal preferences. Further, the personal Internet portal page of the present invention provides an interface to present a registered user with sample software programming code to enable the registered user to integrate a custom section of the personal Internet portal page. Further, the present invention provides an interface that enables a registered user to customize the look and feel of an personal Internet portal page beyond that which is available in the prior art.

As used herein, the terms “user” and/or “user terminal” refer, generally, to a person and/or device operated by a person that establishes a communication session over a network with another device. Also as used herein, the term, “personal Internet portal page” refers, generally, to an Internet portal that is customizable by a user in accordance with the teachings provided herein.

The present invention provides a user who registers with an information processor, for example, by providing at least a user name and password, with tools for developing a personal Internet portal page to suit the desires of many different people. After a user registers, the user can design his own layout and appearance for the portal page. The user is preferably able to resize sections portal page, and to select colors, fonts and point sizes of content displayed in the portal page. Further, the user can capture fast moving information such as a moving stock ticker, by selecting predetermined Internet sources of current and up-to-date information. Of course, one skilled in the art will recognize that a fast-moving stock ticker may be constructed by frequently refreshing an image file, thereby giving the impression of fast moving animation.

Preferably, menu selections are provided to the user for popular sources of content, including national and international news sources, financial market information, entertainment information, sports information, weather information, and e-mail-related information. Preferably, a user makes portal design choices, and the information content is provided in the personal Internet portal page, when the user accesses the page.

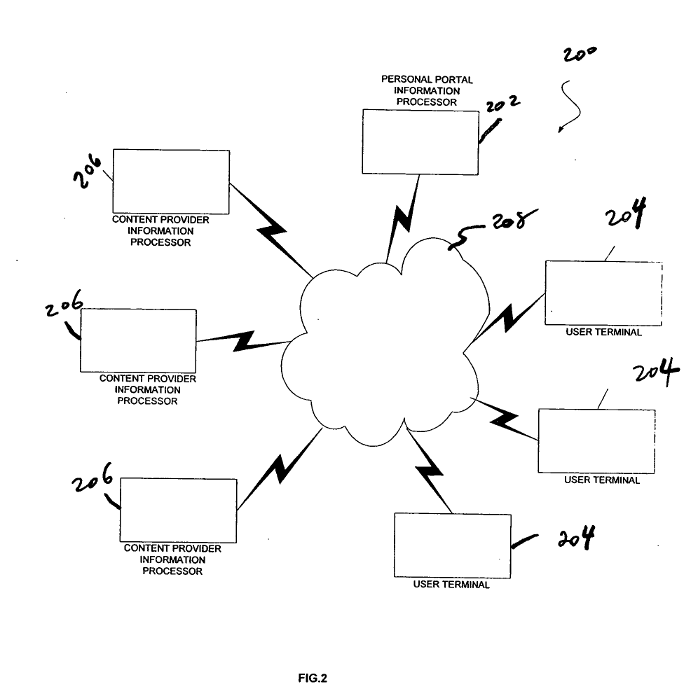

FIG. 2 shows an example of a preferred embodiment of the present invention, including a hardware arrangement for providing personal Internet portal pages, and referred to generally as system 200. System 200 comprises at least one personal portal information processor 202, at least one user terminal 204, and at least one content provider information processor 206, each of which is adapted to access and communicate over communication network 208. Personal portal information processor 202 preferably provides personal Internet portal pages for registered users operating user terminals 204.

Personal portal information processor 202 preferably includes all databases necessary to support the present invention. However, it is contemplated that personal portal information processor 202 can access any required database via communication network 208 or any other communication network to which personal portal information processor 202 may be coupled. Communication network 208 is preferably a global public communication network such as the Internet, but can also be a wide area network (WAN), local area network (LAN), or other network that enables two or more computers to communicate with each other.

In the preferred embodiment, personal portal information processor 202, user terminal 204 and personal portal information processor 202 are any devices that are capable of sending and receiving data across communication network 208, e.g., mainframe computers, mini computers, personal computers, laptop computers, a personal digital assistants (PDA) and Internet access devices such as Web TV. In addition, personal portal information processor 202, user terminal 204 and personal portal information processor 202 are preferably equipped with a web browser, such as MICROSOFT INTERNET EXPLORER, NETSCAPE NAVIGATOR and the like. Information processors 202, 204 and 206 are coupled to communication network 208 using any known data communication networking technology.

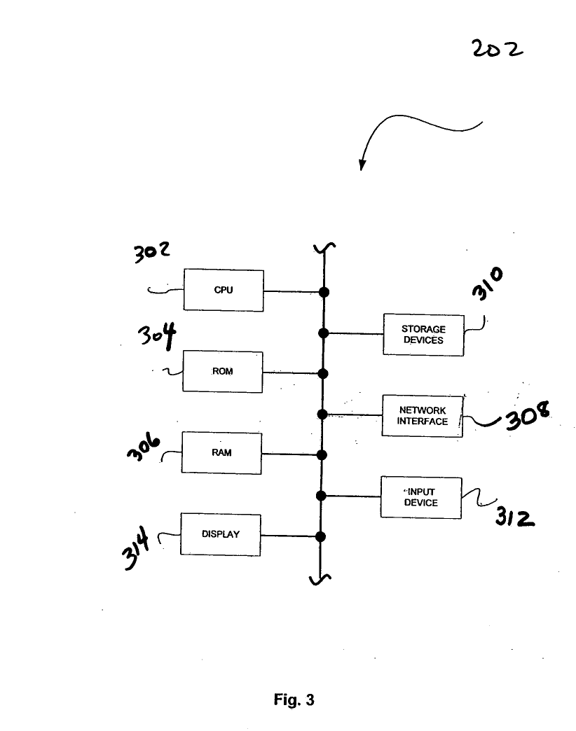

As shown in FIG. 3, the functional elements of each personal portal information processor 202 are shown, and include one or more central processing units (CPU) 302 used to execute software code and control the operation of personal portal information processor 202, read-only memory (ROM) 304, random access memory (RAM) 306, one or more network interfaces 308 to transmit and receive data to and from other computing devices across a communication network, storage devices 310 such as a hard disk drive, floppy disk drive, tape drive, CD ROM or DVD for storing program code databases and application data, one or more input devices 312 such as a keyboard, mouse, track ball, microphone and the like, and a display 314.

The various components of personal portal information processor 202 need not be physically contained within the same chassis or even located in a single location. For example, storage device 310 may be located at a site which is remote from the remaining elements of personal portal information processor 202, and may even be connected to CPU 302 across communication network 208 via network interface 308. Personal portal information processor 202 preferably includes a memory equipped with sufficient storage to provide the necessary databases, forums, and other services as well as acting as a web server for communicating hypertext markup language (HTML), Java applets, XML code, Active-X control programs or the like to user terminals 204. Personal portal information processor 202 is arranged with components, for example, those shown in FIG. 3, suitable for the expected operating environment of personal portal information processor 202. The CPU(s) 302, network interface(s) 308 and memory and storage devices are selected to ensure that capacities are arranged to accommodate expected demand.

In a preferred embodiment of the present invention, personal portal information processor 202 employs a variety of technologies to create a rich and dynamic user experience. For example, information processor 202 is a UNIX based server running APACHE web server, PHP, and MYSQL. Further, MACROMEDIA FLASH is preferably used to create a user customizable interface. Data are preferably provided between the information processor 202 and user terminal 204 via web-services protocols. As described in detail below, Internet portal sections display data provided by registered users. The portal sections are added through a manual update with MACROMEDIA FLASH files supplied by a data feed. Further, in addition to APACHE, MYSQL, and PHP, NUSOAP is preferably used to transfer information between user terminal 204 and information processor 202.

As used herein, the terms “link” and “hyperlink” refer to a selectable connection from one or more words, pictures or other information objects to others in which the selectable connection is presented within the web browser. The information object can include sound and/or motion video. Selection is typically made by “clicking” on the link using an input device such as a mouse, track ball, touch screen and the like. Of course, one of ordinary skill in the art will appreciate that any method by which an object presented on the screen can be selected is sufficient.

The functional elements of personal portal information processor 202 shown in FIG. 3 are of the same categories of functional elements present in user terminals 204 and personal portal information processor 202. However, not all elements need be present in the user terminal 204 and/or the personal portal information processor 202. For example, storage devices, in the case of PDA's, and the capacities of the various elements are arranged to accommodate the expected user demand. For example, CPU 302 in user terminal 204 may be a smaller capacity CPU than the CPU present in the personal portal information processor 202. Similarly, it is likely that the personal portal information processor 202 will include storage devices of a much higher capacity than storage devices present in user terminal 204. Of course, one of ordinary skill in the art will understand that the capabilities of the functional elements can be adjusted as needed.

The nature of the invention is such that one skilled in the art of writing computer executable code (i.e., software) can implement the functions described herein using one or more of a combination of popular computer programming languages and developing environments including, but not limited to, C, C++, Visual Basic, JAVA, HTML, XML, ACTIVE SERVER PAGES, JAVA server pages, servlets, and a plurality web site development applications.

Although the present invention is described by way of example herein and in terms of a web-based system using web browsers and a web site server (e.g., personal portal information processor 202), system 200 is not limited to such a configuration. It is contemplated that system 200 is arranged such that user terminal 204 communicates with and displays data received from personal portal information processor 202 using any known communication and display method, for example, using a non-Internet browser WINDOWS viewer coupled with a local area network protocol such as the Internet Packet Exchange (IPX), dial-up, third-party, private network or a value added network (VAN).

It is further contemplated that any suitable operating system can be used on personal portal information processor 202 and user terminal 204, for example, DOS, WINDOWS 3.x, WINDOWS 95, WINDOWS 98, WINDOWS NT, WINDOWS 2000, WINDOWS ME, WINDOWS CE, WINDOWS POCKET PC, WINDOWS XP, MAC OS, UNIX, LINUX, PALM OS, POCKET PC and any other suitable operating system.

As used herein, references to displaying data on personal portal information processor 202 and user terminal 204 regard the process of communicating data across communication network 208 and processing the data such that the data are viewed on a display 44, for example by using a web browser and the like. As is common with web browsing software, the display 314 on user terminal 204 presents sites within the system 200 such that a user can proceed from site to site within the system by selecting a desired link.

Therefore, each user's experience with system 200 is based on the order with which he/she progresses through the display screens. Graphic controls are preferably available in the display screens and modules to initiate data processes, and to provide convenient navigation between the display screens and modules of system 10. In other words, because the system is not completely hierarchical in its arrangement of display screens, users can proceed from area to area without the need to “backtrack” through a series of display screens. For that reason, and unless explicitly stated otherwise, the following discussion is not intended to represent any sequential operation steps, but rather to illustrate the components of system 10.

As used herein, the term, “module” refers, generally, to one or more discrete components that contribute to the effectiveness of the present invention. Modules can operate or, alternatively, depend upon one or more other modules in order to function.

The present invention is directed to providing a personal Internet portal page that can be customized by a user. A registered user can access his personal Internet portal page by establishing a session with a portal server that provides personal Internet portal pages, and, thereafter, by submitting an authorized user name and password in a log-in portion in a web browser display screen. Unregistered users are preferably not able to access a personal Internet portal page. Once a registered user submits his or her user name and password (i.e., logs in), an identifier, such as an Internet cookie, is preferably stored on user terminal 204 and referenced by personal portal information provider 202 in the future. Once the cookie or other identifier is referenced, the user can elect to bypass the log-in portion of the web page and, instead, be presented with his personal Internet portal page, substantially automatically.

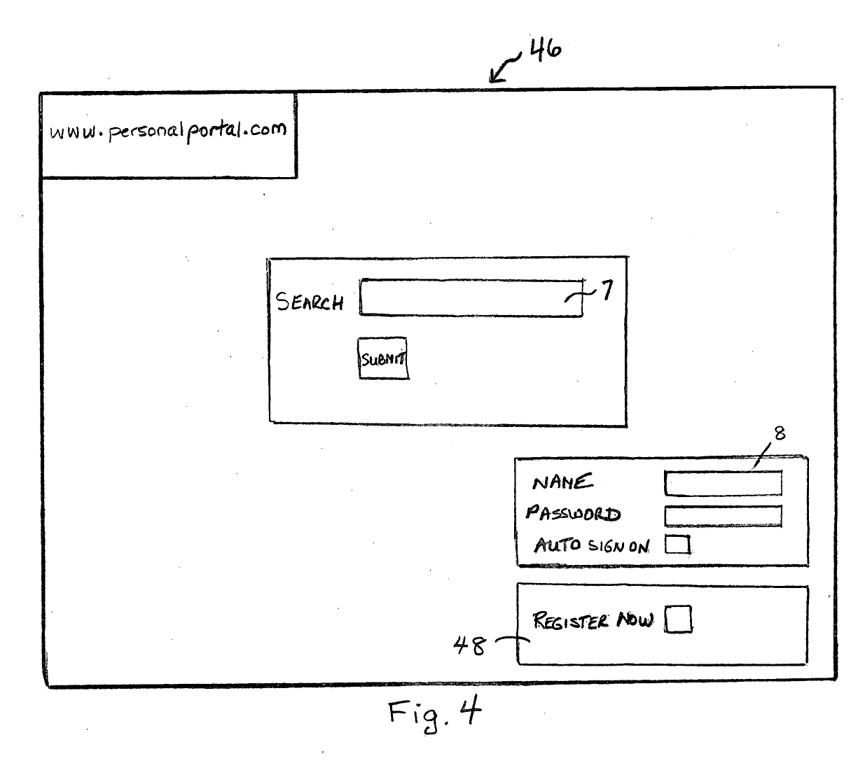

FIG. 4 is an example display screen 400 that is presented by personal portal information processor 202 when a user terminal 204 establishes a communication session therewith. In a preferred embodiment, display screen 400 includes search text box 107 that provides users with search engine-related functionality. Preferably, personal portal information processor 202 employs a database, a web crawler and other technology common to prior art search engines to enable a user to search for and locate content on Internet web sites. The search engine preferably sorts a list of web pages represented by a user's search criteria according to a user's preference, for example, by the degree of relevance each page has with respect to the user's search criteria.

Although typical prior art Internet-based portal pages include a control for searching for content on the Internet, the invention is not so limited. It is envisioned herein that a control, such as a text box, that enables a user to search for content is optional and not a requirement of system 200. If a user desires to add a search text box to his or her personal portal page, such an option may be available.

Display screen 400 also includes login box 402 for registered users to submit user names and passwords. Unregistered users can select Register Now hyperlink 404 to submit registration information, such as a new user name and password.

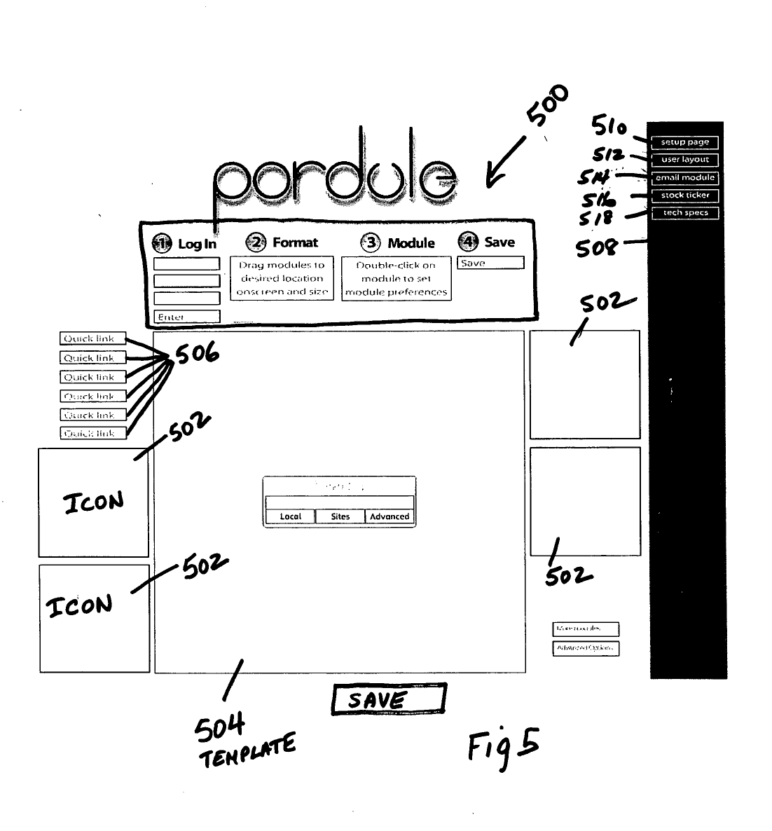

FIG. 5 is an example personal Internet portal page design display screen 500 that is provided to an authorized user of the present invention. Display screen 500 includes screen controls that can be selected by the user to design a personal Internet portal page. In the example embodiment shown in FIG. 5, a user can choose from various services provided by personal portal information processor 202 by selecting from menu choices and icons representing information, in order to place such selected information on the user's personal Internet portal page. The services offered for the user's selection include, for example, news, sports scores, weather information, market information, e-mail, and hyperlinks to preferred web sites.

The example embodiment design display screen 500 comprises a sample template that is presented to a registered user for developing a personal Internet portal page. The example display screen 500 includes icons 502 for defining portal sections to be included in the personal Internet portal page. In an example embodiment, a registered user selects icon 502, for example by clicking with a mouse, and dragging the icon into a desired area of portal template 504. Preferably, once icon 502 is placed in a desired area of template 504, the registered user can select one of the sides or a comer of icon 502 to size the icon according to the user's preferences. The user proceeds by dragging icons 502 into template 504, sizing the icons to the user's preferences in order to define a custom portal page layout in accordance with a user's preferences. After the user has positioned an icon 502 into template 504, the user preferably uses a selection device, such as a mouse, and selects the icon 502, such as by double clicking or selecting an expansion button, in order to define additional preferences. For example, once the user has double clicked icon 502 within template 504, the user is presented with a list of choices of content to be displayed at the location of icon 502. For example, a list is presented to the user for choosing various web site content, including sports information, news information, financial markets information, weather information, entertainment information, or the like. Furthermore, the user is preferably able to select content and/or software applications (described in greater detail, below) that were provided by the registered user and are available, via information processor 202, after the user (or a different registered user) uploaded the content/applications to information processor 202. For example, the user, having previously uploaded a digital image of the user's family, identifies a representation of the image and the image is displayed in the respective icon 502. In accordance with the present invention, registered users are afforded the opportunity to upload personal content to information processor 202, and the content uploaded thereto can be selected to be accessed in the personal portal page.

In addition to selecting personal content, personal software applications, or web site content via icon 502, the present invention provides a flexible e-mail application that can be selected via icon 502. Preferably, an e-mail client software application is provided by the present invention that enables a user to receive and send e-mail messages to and from a plurality of individual e-mail accounts. For example, a registered user may have one or more personal POP e-mail accounts, as well as a third e-mail account provided by his or her employer. Preferably, the present invention provides an interface that enables the registered user to define parameters for each individual e-mail account. For example, the registered user defines profiles for the respective accounts, including defining a display name, an e-mail address, an incoming mail account (POP3, HDTP, INOP or the like), and an outgoing mail server (e.g., SMTP server). Further, the user defines user names and passwords for the respective e-mail accounts. In this way, the user is afforded an opportunity to review e-mail account activity from a plurality of e-mail accounts via the personal Internet portal page.

In addition to selecting icons 502 and presenting them in template 504 in accordance with a user's preference, quick link icons 506 can be selected by the registered user and dragged into template 504, as described above with respect to icons 502. After quick links 506 are positioned in template 504 according to a user's preferences, the registered user is afforded the opportunity to double click on a respective quick link icon 506 in order to define a hyperlink to a web site on the Internet. Thereafter, when the personal portal page is displayed to the registered user, the registered user can select the hyperlink to the web site, and the web site appears for the user. The respective web site can be displayed to the user in a number of ways, for example, by displaying the web site in a new instance of the web browser software application. In this way, the user can select respective instance of the web browser application for displaying the web site or the custom Internet portal page. In other words, when the user desires to review the web site represented by the hyperlink, then the user selects the web browser instance that displays that web site. When the user desires to review the personal Internet portal page, the user selects the instance of the web browser that displays the portal page. Alternatively, the web site represented by the hyperlink can be displayed as a new page, and the user can navigate using typical web browser back and forward navigation buttons to switch between the personal Internet portal page and the respective web site. In accordance with the present invention, the user can drag any number of quick link icons 506 into template 504.

In accordance with the present invention, significant flexibility is provided for defining custom settings for the respective sections of the personal Internet portal page. For example, a user selects a first icon 502 that has been dragged and sized previously into template 504. The user then defines a plurality of display settings for that respective section represented by the first icon 502. For example, the user can define the background color, text, font and point size, background image, or the like for the respective portal section represented by the first icon 502. The user can select a second icon 502, and define a host of different display settings for the portal section represented by the second icon 502. In this way, the personal Internet portal page of the present invention displays various portal page sections differently, and provides much greater flexibility and design customization than previously available in the prior art.

In addition to designing portal sections via icons 502 and 506, the design display screen 500 includes advanced options 508 for a registered user to take advantage of additional functionality provided by the present invention. In advanced options 508, the user can select set up page 510, user layout 512, e-mail module 514, stock ticker 516 and tech specs 518.

Continuing with the example shown in FIG. 5, set up page 510 enables a registered user to define custom settings that will affect the overall page of the personal Internet portal page. For example, the user can identify a background image, background color, a respective text font type and point size, an audio file that is played upon viewing the personal Internet portal page, or the like. The user can also define the size of a respective page.

User layout 512 enables a registered user to define a default layout that can be applied for future personal Internet portal pages to be developed by the registered user. For example, in accordance with the present invention, a registered user can define a plurality of personal Internet portal pages. Unlike prior art personal portals in which individual users are restricted to one portal page, the present invention allows registered users to define a plurality of personal portal pages that can be selected, for example, depending upon a day of the week or any other criteria desired by the user. By defining a single user layout, via user layout icon 512, a user need only define a series of preferences once and then those preferences are stored, for example, in a template and provided to the registered user whenever a new personal Internet portal page is defined via display screen 500.

E-mail module icon 514 provides a series of controls for a user to define one or more e-mail accounts (described above). For example, the registered user selects e-mail module icon 514 to define e-mail account settings including an outgoing mail server, an incoming mail server, a user account name, a password, or the like.

Stock ticker icon 516 is available for a user to define a particular stock ticker application that the user wants to insert into his or her personal Internet portal page. The present invention preferably allows a user to define a plurality of Internet stock tickers that can be integrated into the personal Internet portal page. The user defines the respective stock ticker applications that the user desires to have displayed in the personal Internet portal page, and further defines the location within template 504 where the user would like the stock ticker application to be displayed.

Tech specs icon 518 provides a registered user with sample software programming code that can be used to define a new section for the personal Internet portal page. For example, a registered user may have a software application for viewing AVI files. In accordance with the present invention, although the personal portal information processor 202 does not, by default, provide registered users with an AVI viewer, registered users can upload to the information processor 202 software applications, such as an AVI file viewer, to be integrated in a personal Internet portal page.

In accordance with the present invention, registered users are requested to follow programming rules such that integration of a software application (e.g., an AVI file viewer) occurs without additional programming or manipulation by the proprietor (or software developer working for the proprietor) of information processor 202. Accordingly, the present invention affords registered users with instructions and sample software programming code that provides the tools necessary for developing and integrating a custom software application into a personal Internet portal page. In this way, a wide range of software applications can be integrated into a registered user's personal portal information page that is otherwise unavailable in the prior art, and without imposing great burdens on the proprietor of information processor 202.

Preferably, any application that is uploaded to information processor 202 is reviewed and certified as acceptable by the proprietor (or authorized representative) of information processor 202 prior to the application being made available for integration into a personal portal page. In this way, malicious software and/or software that does not function according to specification is not distributed via information processor 202.

Furthermore, registered users who upload software applications for integration in a personal Internet portal page can define whether they are willing to share those applications with other registered users. Thus, a registered user who is defining a personal Internet portal page can peruse software applications that have been uploaded by other registered users and can integrate, for example, the AVI file viewer of the previous example into his or her own personal Internet portal page. In an alternative embodiment of the present invention, registered users can charge other registered users a fee for using a software applications that is uploaded to information processor 202. Registered users who desire to integrate a software application into their personal Internet portal pages pay a fee for the right to use the software application. In such a case (and in one embodiment), the registered user who provides the software application initially receives the full fee. Alternatively, the fee is shared between the registered user who submits the software application and the proprietor of information processor 202. Of course, one skilled in the art will recognize that other fee sharing structures are possible. For example, the present invention envisions a fee structure in which fees are shared with an original developer of a software application, in case the software developer is not the registered user who uploads the application to personal portal information processor 202.

By providing rules and sample programming code for registered users, the present invention affords great flexibility with respect to personal Internet portal page development. Unlike prior art portals that restrict content to web site content and/or content located on a user's local computer system, the present invention allows users to upload software applications that can be shared among registered users.

In yet another embodiment of the present invention, a personal Internet portal page is defined by a representative of a company and employees of the company use the personal Internet portal page to run software applications that have been uploaded by the company. For example, a company that specializes in the transportation of goods develops a package tracking software application. The package tracking software application is uploaded to information processor 202, and registered users who work for the company access the personal Internet portal page to use the software for tracking packages. In this way, companies can upload custom software applications to be used by a limited number of people for business purposes.

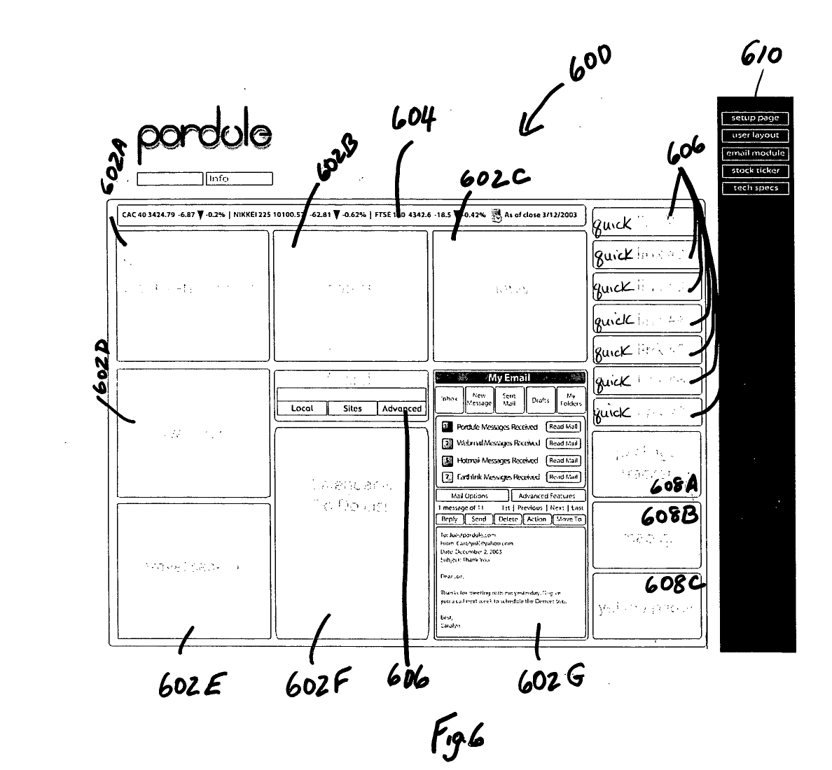

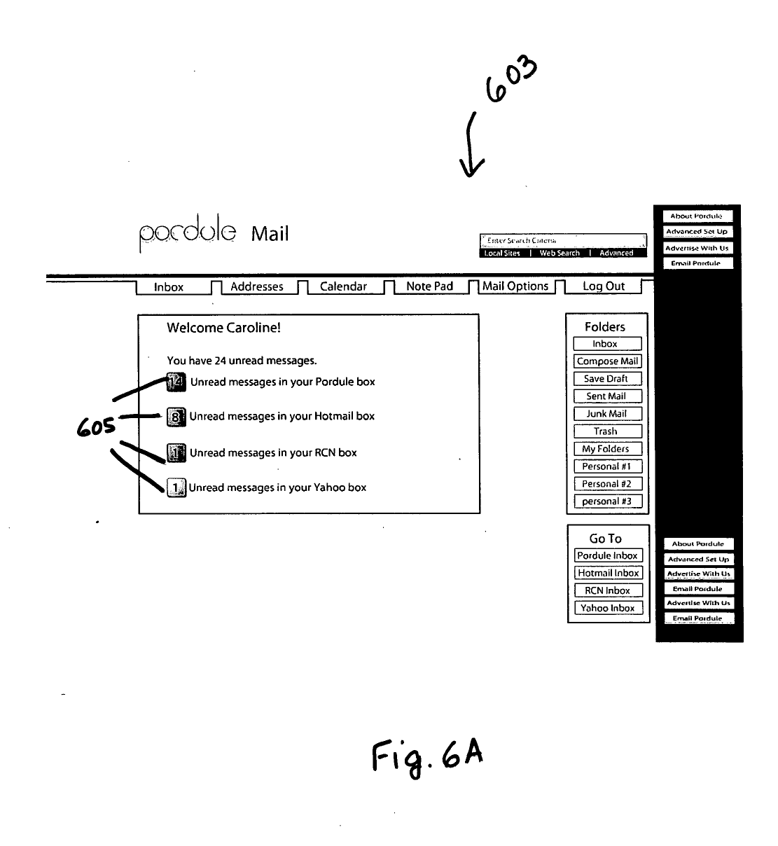

FIG. 6 shows an example personal Internet portal page 600 that is displayed to a registered user after the portal page 600 was designed via display screen 500. As shown in FIG. 6, portal page sections 602 contain various content selected by the registered user during the set up process, described above. For example, portal section 602(a) comprises an image previously uploaded by a registered user and displayed in a personal Internet portal page 600. Portal sections 602(b) through 602(e) contain Internet web site content, including sports information, news, weather and travel information, respectively, that were selected by the registered user. Portal section 602(f) contains a calendar and to-do list that is preferably provided by portal information processor 202 and selected by the registered user during the set up process.

Continuing with the example embodiment shown in FIG. 6, portal section 602(g) displays e-mail information for a plurality of e-mail accounts, as shown in section 602(g), four e-mail accounts are identified (PORDULE, WEBMAIL, HOTMAIL and EARTHLINK). Displayed above the listing of e-mail accounts are five icons for reviewing a respective in-box, providing a new message, reviewing mail previously sent (sent mail), reviewing drafts of e-mail, and folders of e-mail sent and received by the registered user. In the lower portion of section 602(g), a specific e-mail message is displayed for the registered user. Displayed above the e-mail message are a series of icons for replying to the message, sending the message, deleting the message, performing actions on the message and moving the message to a particular folder. Thus, in accordance with the present invention, a functional e-mail client is displayed in the personal Internet portal page 600 that provides access to a plurality of e-mail accounts. In accordance with the present invention, a registered user does not have to launch separate e-mail client software applications in order to review e-mail from a plurality of e-mail accounts. Instead, the registered user has very convenient access to a plurality of e-mail accounts in a single display section of Internet portal display screen 600.

In accordance with an example embodiment of the present invention, a registered user receives notification that unread messages are located in the plurality of e-mail accounts. FIG. 6A shows an example e-mail notification display screen 603 that is provided to a registered user once the registered user successfully logs into information processor 202. As shown in FIG. 6A, 24 unread messages are available for the registered user, Caroline, and the number of messages in each respective e-mail account is preferably shown. The registered user selects icon 605 to access a respective e-mail account and retrieve the unread messages therein.

Continuing now with reference to FIG. 6, stock ticker 604 is displayed that shows current stock activity. Moreover, in section 606, a plurality of quick links are provided that enable a registered user to select a hyperlink to a pre-identified Internet web site. As described above with respect to FIG. 5, a user merely selects quick link 606 and the Internet web site appears, for example, in a new instance of an Internet browser or in the same instance of the Internet browser application and in a new page. In the latter example, the user navigates back (e.g., by selecting the back icon in the web browser toolbar) and is again presented with the personal Internet portal page 600.

Continuing with the example personal Internet portal page 600 shown in FIG. 6, portal sections 608(a)-608(c) represent software applications that are integrated into personal Internet portal page 600. As shown in the example portal page section 608(a), a package tracking software application is provided that enables the registered user to run a software program for tracking the whereabouts of a package that is shipped in transit. Portal section 608(b) provides a mapping software application that provides, for example, street and area maps for locations throughout the world. Portal section 608(c) is a custom yellow pages software application that allows a registered user to look up a particular business, including address and telephone number and organized by topic. Thus, personal Internet portal page 600 provides a registered user with a convenient integrated display screen that provides much more information and content than is available in the prior art. Although the example display screen 600 shown in FIG. 6 has a uniform appearance with respect to the particular portal sections, the invention is not so limited. As described above with respect to FIG. 5, each individual portal section (602(a)-602(f), 604, 606 and 608(a)-608(c)) can be tailored to accommodate a registered user's personal preferences. In this way, the look and feel of the personal Internet portal page 600 can be represented in a virtually unlimited number of formats and styles.

Also shown in FIG. 6, setup section 610 enables a user with a convenient access to the setup and definition portions provided by the portal information processor 202, described above with respect to FIG. 5. For example, in section 610, the registered user define a page layout, define a user layout, define e-mail accounts, define a stock ticker and receive technical specifications with respect to uploading software applications to the personal Internet portal information processor 202.

In addition to providing an individual access to a personal Internet portal page, the present invention preferably affords an organization, such as a business entity, with administrative functionality. For example, an administrative user who has authority over employees in a business can use the present invention to restrict or limit access to one or more personal Internet portal pages. Also, an administrative user can use the present invention to identify non-administrative users who are not entitled to access a personal Internet portal page.

FIG. 7 is a flow chart showing a high level representation of administrative functionality provided by system 10. As used herein, the term, administrative user, refers generally to a person, department, organization, or the like that has authority over another person, department, organization or the like. Referring now to FIG. 7, an administrative user provides a user name and password (step S700). If information processor 202 does not recognize the combination of user name and password as an administrative user, then the log in attempt fails (step S702). If information processor 202 recognizes the combination of user name and password as an administrative user, then the log in attempt succeeds (step S704), and the administrative user is provided an administrative user display screen. In step S706, the administrative user can develop a personal Internet portal page (substantially as described above). In accordance with the present invention, one or more portal sections may be provided that include content and/or software applications that are unavailable to non-administrative users. In this way, administrative users have access to restricted content and can develop personal Internet portal pages that contain restricted content.

Continuing with the flow chart shown in FIG. 7, in step S708, administrative users are provided administrative functionality with respect to other administrative users. For example, in step S710 a new administrative user can be added, in step S712 an administrative user e-mail account can be provided, and in step S714, various access levels can be defined.

In addition to managing accounts for administrative users, in step S716, an administrative user can perform functions for non-administrative users. For example, a non-administrative user account that provides access to a personal Internet portal page can be suspended (step S718) banned (step S720), or viewed, added, searched, removed or modified (step S722). Further, a non-administrative user e-mail account can be configured in step S724.

Thus, the present invention provides greater flexibility and functionality over prior art portals. Other uses and products provided by the present invention will be apparent to those skilled in the art. Although the present invention has been described in relation to particular embodiments thereof, many other variations and modifications and other uses will become apparent to those skilled in the art. It is preferred, therefore, that the present invention be limited not by the specific disclosure herein.

1. A system for displaying a personal portal page, the system comprising:
an Internet content storage module operable to receive and store content from a pre-identified Internet web site in a memory;
a personal content storage module operable to receive and store at least one of content and a software application from a user in the memory, wherein the personal content storage module is adapted to receive a software application from the user for integration into the personal portal page;
a content selection module operable to receive a selection from the user representing at least one of the content from the Internet web site and the at least one of the content and the software application from the user;
a portal page layout module operable to place only the at least one of the content and the software application represented by the selection from the user in the personal portal page according to a predefined specification; and
a portal page layout modification module operable to receive input from the user that represents at least one change to the predefined specification, wherein the portal page layout modification module uses the input from the user to modify the predefined specification, and to display the personal portal page according to the modified predefined specification.

2. The system of claim 1, further comprising a content restriction module, wherein the at least one of the content and the software application is restricted from an other user.

3. The system of claim 2, further comprising a fee schedule module, wherein a fee is charged to the other user for access to the at least one of content and a software application.

4. The system of claim 1, further comprising a technical specification module, the technical specifications module providing software programming code to the user to integrate the software application into the personal portal page.

5. The system of claim 1, further comprising a portal section layout module that is operable within the portal page layout modification module to define specifications for each respective ones of portal sections.

6. The system of claim 5, wherein the specifications include at least one of background color, text font type, text point size, background image, and border color.

7. The system of claim 1, further comprising a personal portal page template module that defines a template for future personal portal page development and based upon the input received by the portal page layout modification module.

8. The system of claim 1, further comprising an administrative user module that enables the user to restrict access to the at least one of the content and the software application by an other user.
